(19) United States
(12) Patent Application Publication
(10) Pub. No.: US 2008/0114573 A1
(43) Pub. Date: May 15, 2008

(54) Tag organization methods and systems

(75) Inventors: Wen-Tai Hsieh, Taipei (TW); Wei-Shen Lai, Taipei (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/641,699

(22) Filed: Dec. 20, 2006

(30) Foreign Application Priority Data
Nov. 10, 2006 (TW) 95141653

(51) Int. Cl. G06F 17/15; G06F 17/30

(52) U.S. Cl. 703/2; 707/3; 707/E17.107

(57) ABSTRACT

In a tag organization method a plurality of tags are received for tagging network resources. A range of resources tagged by each tag is determined for generating a hierarchical relationship network of tags according to the range of resources tagged by each tag. The hierarchical relationship network serves a graphical guide to facilitate resource searches, adjustment of search scope, to improve recall and precision, and ameliorate basic tag differences.

### BACKGROUND OF THE INVENTION

1. Field of the Invention

The invention relates to computer techniques, and more particularly to tag organization methods.

2. Description of the Related Art

As Web 2.0 concepts are introduced, websites, such “Del.icio.us”, are increasingly utilizing folksonomy methodology. Unlike taxonomies where resources are classified by professionals or authors, folksonomy allows users to classify websites, files, digital images, and other resources. Tags are keywords or descriptive expressions utilized to label resources. FIG. 1 shows an example of a TagCloud.

In FIG. 1, the greater the font size of a tag, the more resources the tag represents. A web server may utilize a webpage to receive a tag, a URL (uniform resource locator) of a resource labeled by the tag, description and notes about the resource, and add the tag to the TagCloud. When the tag is selected, the web server redirects a user to the resource.

An identical tag may target irrelevant resource objects. For example, MIT may represent both “Made in Taiwan” and “Massachusetts Institute of Technology”. This problem may diminish search precision. Different tags may also target identical objects. For example, tags “cat” and “cats” may label the same webpage, and tags “New York” and “New_York” may both represent a resource New York City. Tags may be synonyms or relatives, such as relevant tags “perl”, “javascript”, and “programming”, or relevant tags “java”, “jdk” and “j2ee”. This further diminishes search recall.

### BRIEF SUMMARY OF THE INVENTION

Tag organization methods are provided. An exemplary embodiment of a tag organization method comprises the following steps. A plurality of tags for tagging network resources is received. The range of resources tagged by each tag is determined. A hierarchical relationship network of the tags is generated according to the determined range of each tag. Nodes in the network respectively represent the tags. The hierarchical relationship network facilitates resource searches.

Tag organization systems are provided. An exemplary embodiment of a tag organization system comprises a tag handler, an organizer, and a search module. The tag handler receives a plurality of tags for tagging network resources. The organizer determines the range of resources tagged by each tag, generates a hierarchical relationship network of the tags according to the determined range of each tag. Nodes in the network respectively represent the tags. The search module utilizes the hierarchical relationship network to facilitate resource searches.

An exemplary embodiment of a tag organization method comprises the following steps. A plurality of tags for tagging network resources, comprising a first tag and a second tag, is received. The resource set tagged by each tag is identified. When the first and second tags respectively correspond to resource sets O_{A} and O_{B} with common resources, and the set O_{A} is greater than set O_{B}, and the proportion of the common resources in the set O_{B} is greater than a predetermined ratio, it is determined that the second tag belongs to the first tag.

Tag organization methods and systems may be implemented by a computer application stored on a storage medium such as a memory or a memory device. The computer application, when loaded into a computer, directs the computer to execute the previously-described method.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a TagCloud;

FIG. 2 is a block diagram of the configuration of an exemplary embodiment of a tag organization system;

FIGS. 3a˜3j are schematic views of an exemplary embodiment of a hierarchical relationship network;

FIG. 4 is a flowchart of an exemplary embodiment of a tag organization method;

FIG. 5 a flowchart of an exemplary embodiment of a method for constituting a hierarchical relationship network of tags;

FIG. 6 is a schematic view of an exemplary embodiment of a hierarchical relationship network with weighted links; and

FIG. 7 is a schematic view of a network system comprising a plurality of computers.

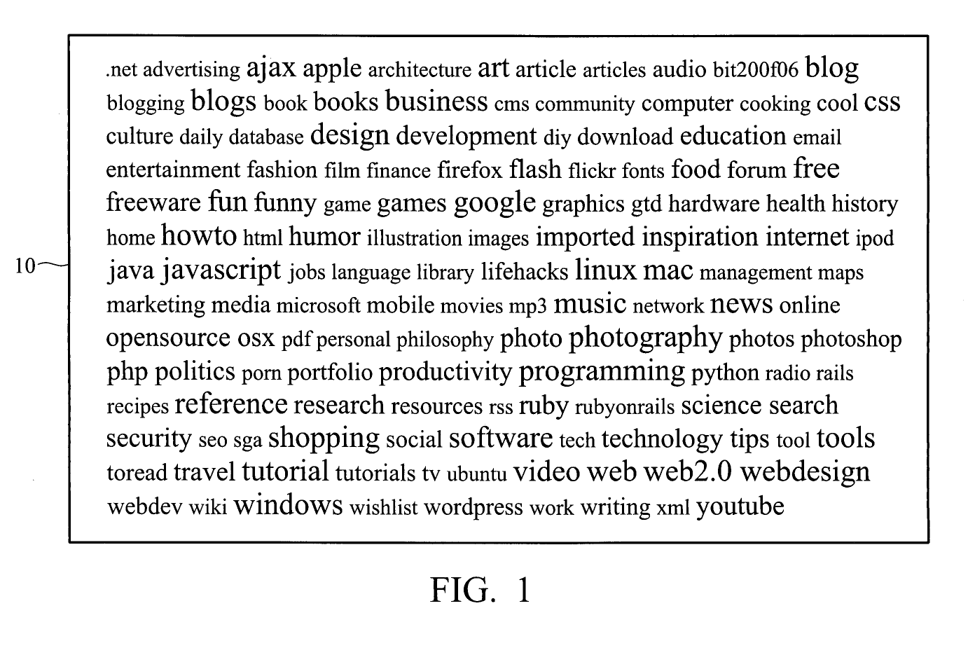

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Tag organization methods and systems are provided in the following. An exemplary embodiment of a tag organization method comprises tag acquisition, classification, data search assistance, searching, and search result ranking and arrangement.

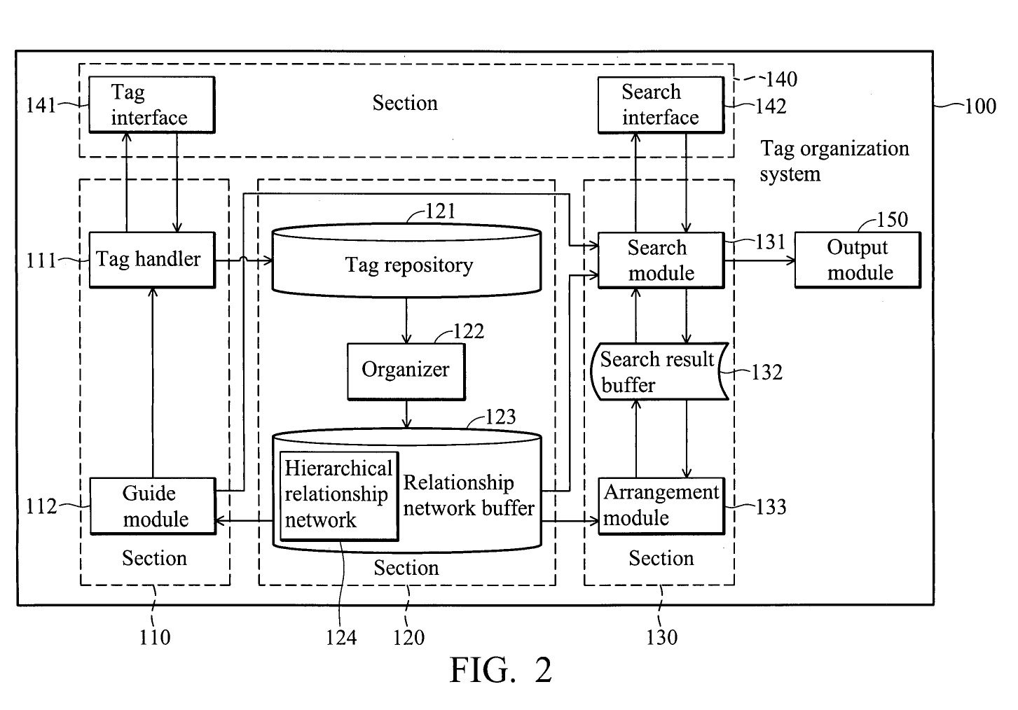

FIG. 2 shows an exemplary embodiment of a tag organization system.

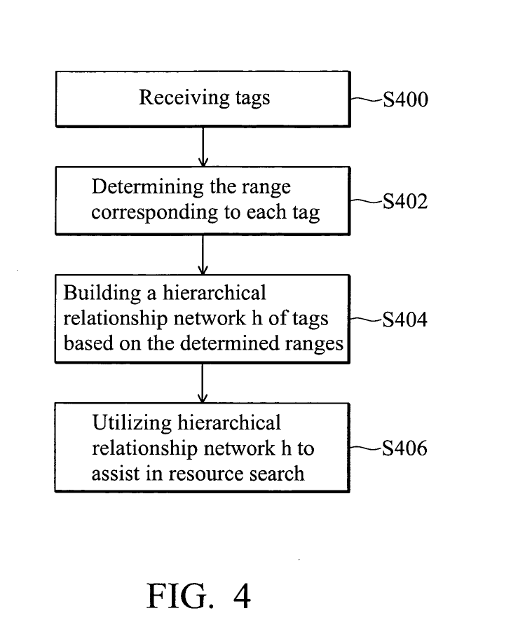

With reference to FIGS. 2 and 4, modules in sections 110, 120, and 130 respectively organize and process tags, and search resources. Section 140 comprises graphical user interfaces (GUIs), comprising tag interface 141 and search interface 142. Tag handler 111 receives and inputs a tag and corresponding resources (such as web pages, pictures, documents, and other network resources) through tag interface 141 tag repository 121 (step S400). Organizer 122 determines the range of resources labeled by each tag (step S402) and builds relationships between tags in tag repository 121 based on the determined range corresponding to each tag, and makes tags in tag repository 121 nodes in the relationship network (referred to as hierarchical relationship network H) (step S404). Modules in section 130 utilize a hierarchical relationship network H to facilitate resource searches (step S406). For example, search module 131 receives and utilizes strings or keywords through interface 142, to search, locate and store search results to buffer 132. Arrangement module 133, utilizing the hierarchical relationship network calculates information density index for each instance of a network resource in the search results, sorts the network resources based on the information density index thereof, and stores the sorted resources to buffer 132. Output module 150 displays sorted network resources in the search results. Search module 131 may display a hierarchical relationship network H or certain nodes thereof through search interface 142 to facilitate resource searches.

The following table 1 shows the relationship between exemplary tags and resources, wherein any number common to a tag and a resource is the number of times tag handler 111 receives the same tag for labeling the same resource.

TABLE 1

| | Resource | | | | | |
|---|---|---|---|---|---|---|
| | First step to | Encyclopedia | J2ME | | C# step | Java & |
| Tag | Java | of PHP | intro | Programming | by step | J2ME |
| Sun | 22 | 00 | 11 | 21 | 00 | 05 |
| programming | 94 | 27 | 00 | 33 | 12 | 01 |
| Java | 45 | 00 | 21 | 04 | 24 | 23 |
| JDK | 21 | 00 | 00 | 11 | 00 | 12 |
| J2SE | 00 | 00 | 00 | 02 | 13 | 01 |
| C# | 00 | 01 | 00 | 00 | 44 | 03 |
| J2ME | 00 | 00 | 06 | 03 | 00 | 00 |
| J2EE | 00 | 00 | 34 | 01 | 00 | 23 |
| PHP | 00 | 48 | 00 | 00 | 00 | 00 |
| Javascript | 01 | 44 | 00 | 01 | 00 | 00 |
| API | 13 | 12 | 14 | 34 | 11 | 00 |
| JSP | 31 | 00 | 00 | 07 | 00 | 00 |

Table 1 may be represented by the following matrix R corresponding to the tags and resources:

$$R = \vert \begin{matrix}22 & 0 & 11 & 21 & 0 & 5 \\ 94 & 27 & 0 & 33 & 12 & 1 \\ 45 & 0 & 21 & 4 & 24 & 23 \\ 21 & 0 & 0 & 11 & 0 & 12 \\ 0 & 0 & 0 & 2 & 13 & 1 \\ 0 & 1 & 0 & 0 & 44 & 3 \\ 0 & 0 & 6 & 3 & 0 & 0 \\ 0 & 0 & 34 & 1 & 0 & 23 \\ 0 & 48 & 0 & 0 & 0 & 0 \\ 1 & 44 & 0 & 1 & 0 & 0 \\ 13 & 12 & 14 & 34 & 11 & 0 \\ 31 & 0 & 0 & 7 & 0 & 0\end{matrix} \vert \qquad ( 1 )$$

Rᵢⱼ is the number of times the ith tag is used as a label for the jth resource,

wherein i and j are integers, and 0≦i<12, 0≦j<6. Organizer 122 may treat the number of resource instances labeled by a tag as the corresponding range of the tag. Thus, organizer 122 can accordingly determine the corresponding range of each tag. For example, the tag “Sun” labels five resource instances: “First step to Java”, “J2ME intro”, “Programming”, “C# step-by-step”, and “Java & J2ME”. The tag JDK labels comprises only three of the described labels. Thus, the corresponding range of the tag “Sun” is greater than that of tag “JDK”.

Organizer 122 makes each tag a node in hierarchical relationship network H according to the corresponding range of each tag. First, organizer 122 sorts the tags based on the corresponding range of each tag. The statistic data of the number of resource instances is shown in Table 2:

| | resource | | | | | | | |
|---|---|---|---|---|---|---|---|---|
| | First | | | | C# | | | |
| | step | | | | step | | | |
| | to | Encyclopedia | J2ME | | by | Java & | resource | Times |
| tag | Java | of PHP | intro | Programming | step | J2ME | instance | used |
| Sun | 22 | 00 | 11 | 21 | 00 | 05 | 4 | 59 |
| programming | 94 | 27 | 00 | 33 | 12 | 01 | 5 | 167 |
| Java | 45 | 00 | 21 | 04 | 24 | 23 | 5 | 177 |
| JDK | 21 | 00 | 00 | 11 | 00 | 12 | 3 | 44 |
| J2SE | 00 | 00 | 00 | 02 | 13 | 01 | 3 | 16 |
| C# | 00 | 01 | 00 | 00 | 44 | 03 | 3 | 47 |
| J2ME | 00 | 00 | 06 | 03 | 00 | 00 | 2 | 9 |
| J2EE | 00 | 00 | 34 | 01 | 00 | 23 | 3 | 58 |
| PHP | 00 | 48 | 00 | 00 | 00 | 00 | 1 | 48 |
| Javascript | 01 | 44 | 00 | 01 | 00 | 00 | 3 | 46 |

The number of resource instances corresponding to each tag is the number of nonzero items in the same row as the tag in Table 1. The times used corresponding to each tag is the total number of times the tag is used as a label for the resources in the same row as the tag. Organizer 122 sorts the tags based on the number of resource instances corresponding to each tag, and if two or more tags corresponding to the same number of resource instances, further sorts these tags according to the corresponding times used . If two or more tags corresponding to the same number of resource instances and the same times used, organizer 122 further sorts the tags based on the times the tags are entered to system 100 respectively. The sort result is shown in table 3:

<CWU−Call number=“24”/>

TABLE 3

| | | | | | | | | |
|---|---|---|---|---|---|---|---|---|
| JSP | 31 | 00 | 00 | 07 | 00 | 00 | 2 | 38 |
| J2ME | 00 | 00 | 06 | 03 | 00 | 00 | 2 | 9 |
| PHP | 00 | 48 | 00 | 00 | 00 | 00 | 1 | 48 |

The sorted tags are respectively “programming”, “Java”, “API”, “Sun”, “J2EE”, “C#”, “Javascript”, “JDK”, “J2SE”, “JSP”, “J2ME”, and “PHP”, which are added sequentially to hierarchical relationship network H.

Organizer 122 may generate table 4 from table 3, in which the relationships between tags and resources are represented as binary numbers:

TABLE 4

| | resource | | | | | |
|---|---|---|---|---|---|---|
| | | | | | C# | |
| | | | | | step | |
| | First step to | Encyclopedia | J2ME | | by | Java & |
| tag | Java | of PHP | intro | Programming | step | J2ME |
| programming | 1 | 1 | 0 | 1 | 1 | 1 |
| Java | 1 | 0 | 1 | 1 | 1 | 1 |
| API | 1 | 1 | 1 | 1 | 1 | 0 |
| Sun | 1 | 0 | 1 | 1 | 0 | 1 |
| J2EE | 0 | 0 | 1 | 1 | 0 | 1 |
| C# | 0 | 1 | 0 | 0 | 1 | 1 |
| Javascript | 1 | 1 | 0 | 1 | 0 | 0 |
| JDK | 1 | 0 | 0 | 1 | 0 | 1 |
| J2SE | 0 | 0 | 0 | 1 | 1 | 1 |
| JSP | 1 | 0 | 0 | 1 | 0 | 0 |
| J2ME | 0 | 0 | 1 | 1 | 0 | 0 |
| PHP | 0 | 1 | 0 | 0 | 0 | 0 |

“1” stands for the existence of a corresponding tag and resource instance, and “0” stands for their absence. The following matrix M can be utilized to represent table 4 and the relationships between tags and resources:

$$M = \vert \begin{matrix}1 & 1 & 0 & 1 & 1 & 1 \\ 1 & 0 & 1 & 1 & 1 & 1 \\ 1 & 1 & 1 & 1 & 1 & 0 \\ 1 & 0 & 1 & 1 & 0 & 1 \\ 0 & 0 & 1 & 1 & 0 & 1 \\ 0 & 1 & 0 & 0 & 1 & 1 \\ 1 & 1 & 0 & 1 & 0 & 0 \\ 1 & 0 & 0 & 1 & 0 & 1 \\ 0 & 0 & 0 & 1 & 1 & 1 \\ 1 & 0 & 0 & 1 & 0 & 0 \\ 0 & 0 & 1 & 1 & 0 & 0 \\ 0 & 1 & 0 & 0 & 0 & 0\end{matrix} \vert \qquad ( 2 )$$

A vector Mᵢ represents the tag vector of the ith tag. For example, the 0^{th} tag “programming” has a tag vector [1 1 0 1 1 1].

Organizer 122 may utilizes the following arrays to generate hierarchical relationship network H:
Tag[ ]: storing sorted tags not added to hierarchical relationship network H;
hierarchy[ ]: storing a copy of tags added to hierarchical relationship network H;
Terminal[ ]: storing tags added to hierarchical relationship network H having no child node;
Tag_Relation[ ][ ]: A relationship matrix, also a (0, 1)-matrix, in which Tag_Relation[x][y]=1 indicates that the xth tag is the child node of the yth tag, and x and y are both positive integer.

Hierarchical Relationship Network Constitution:

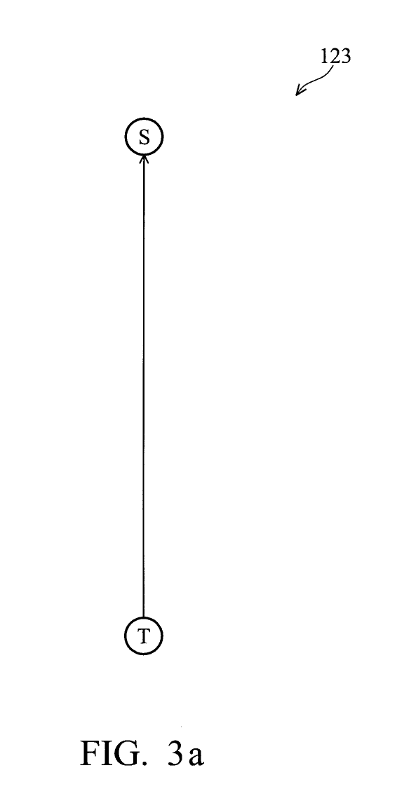

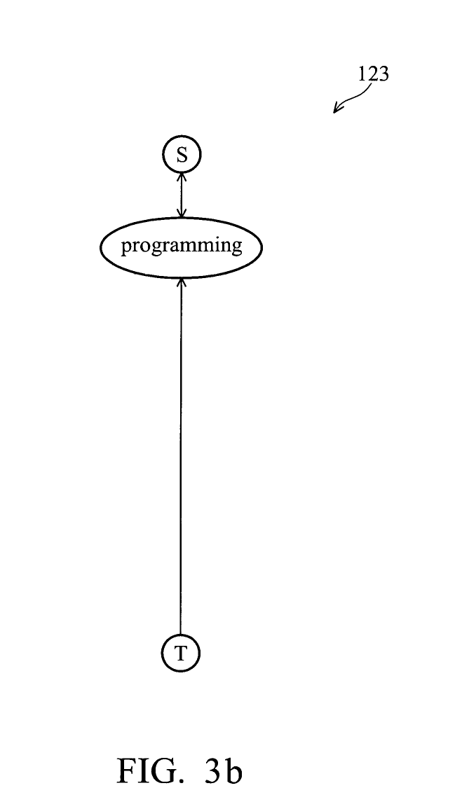

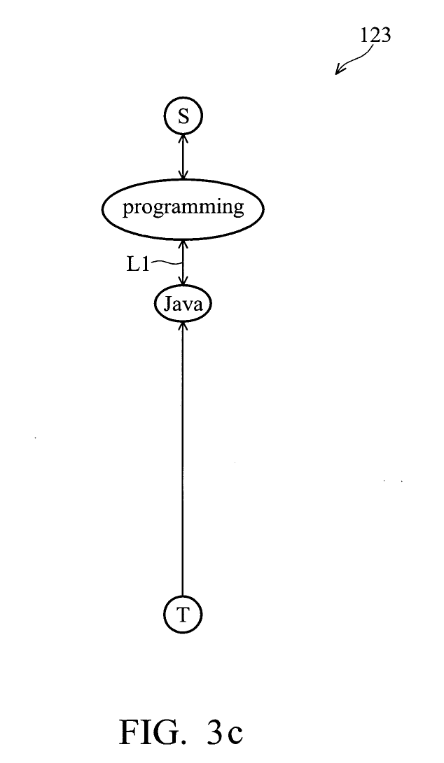

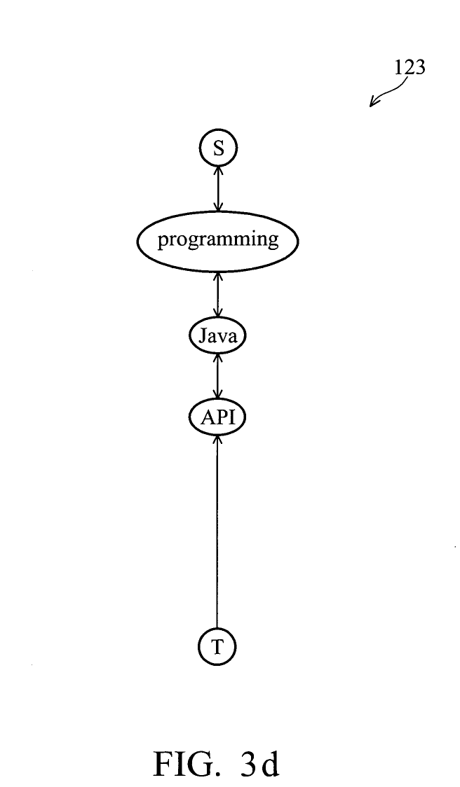

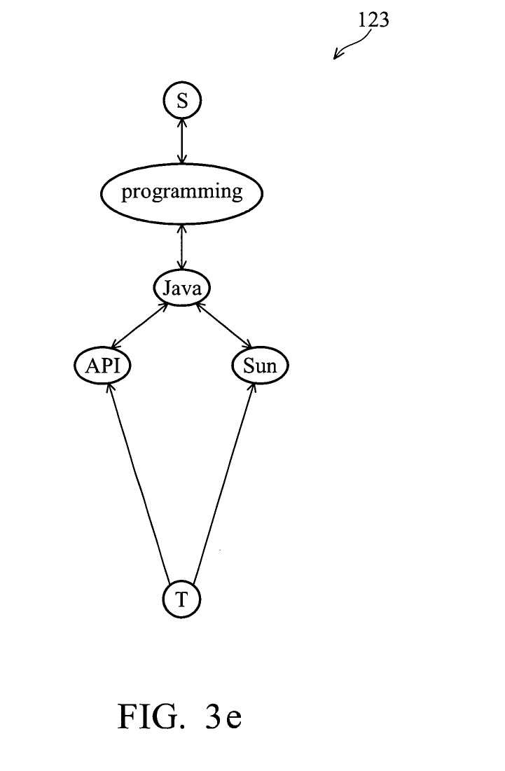

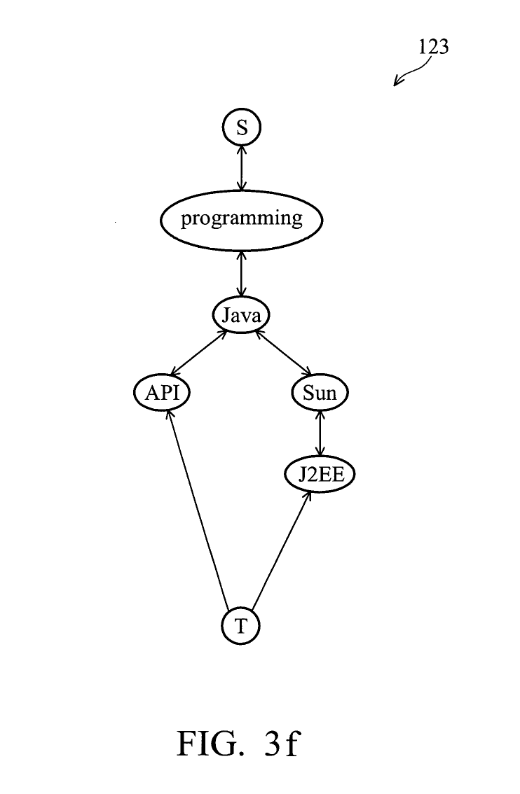

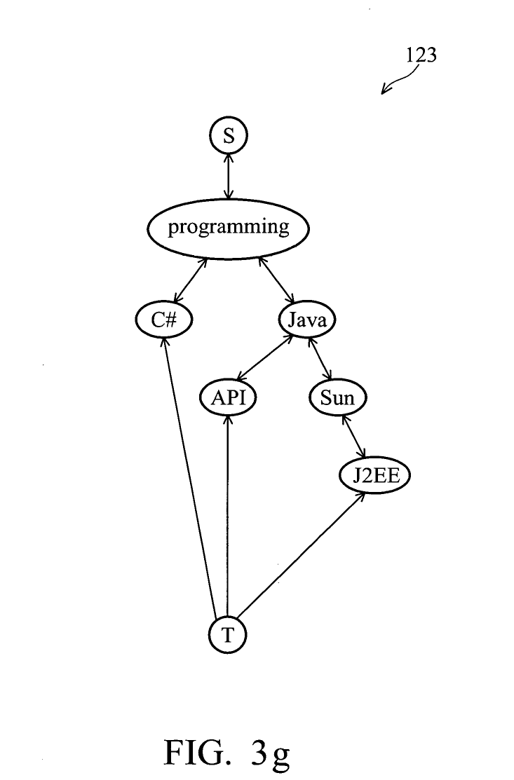

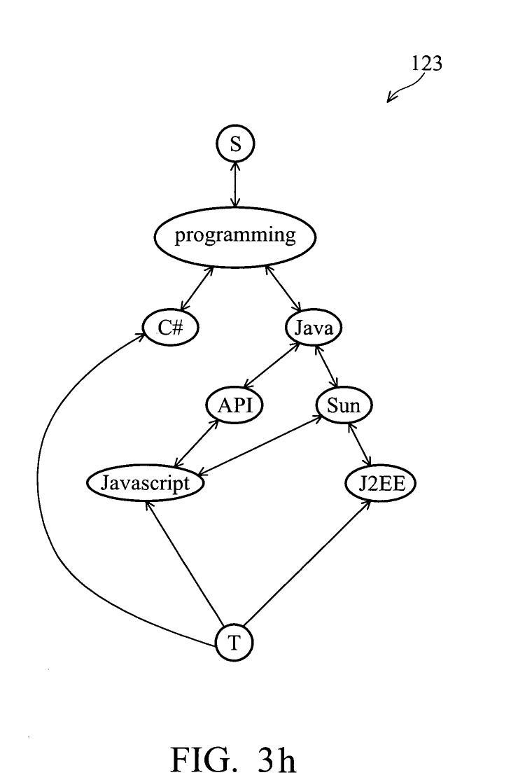

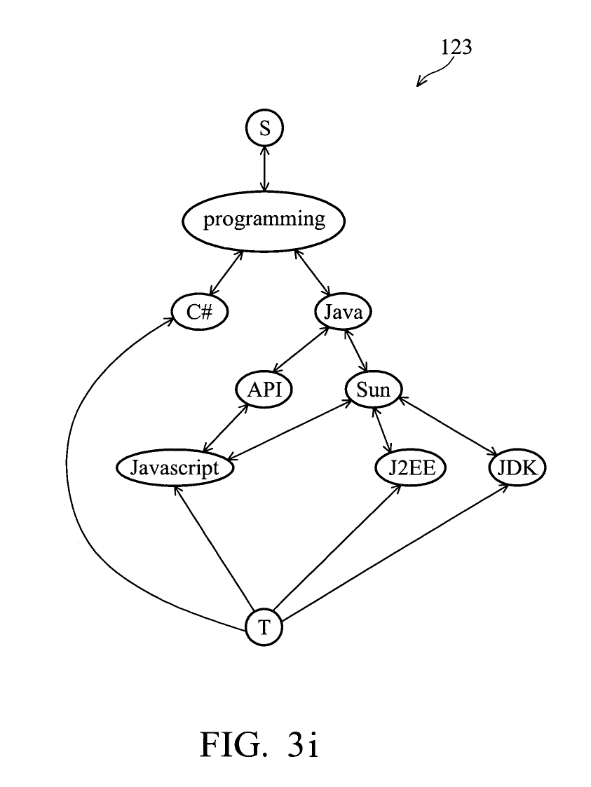

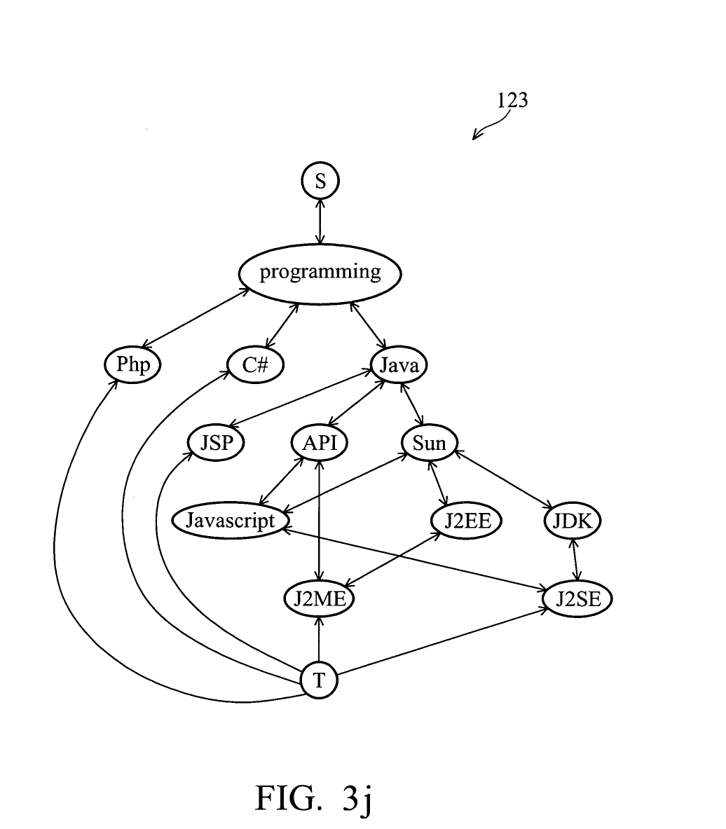

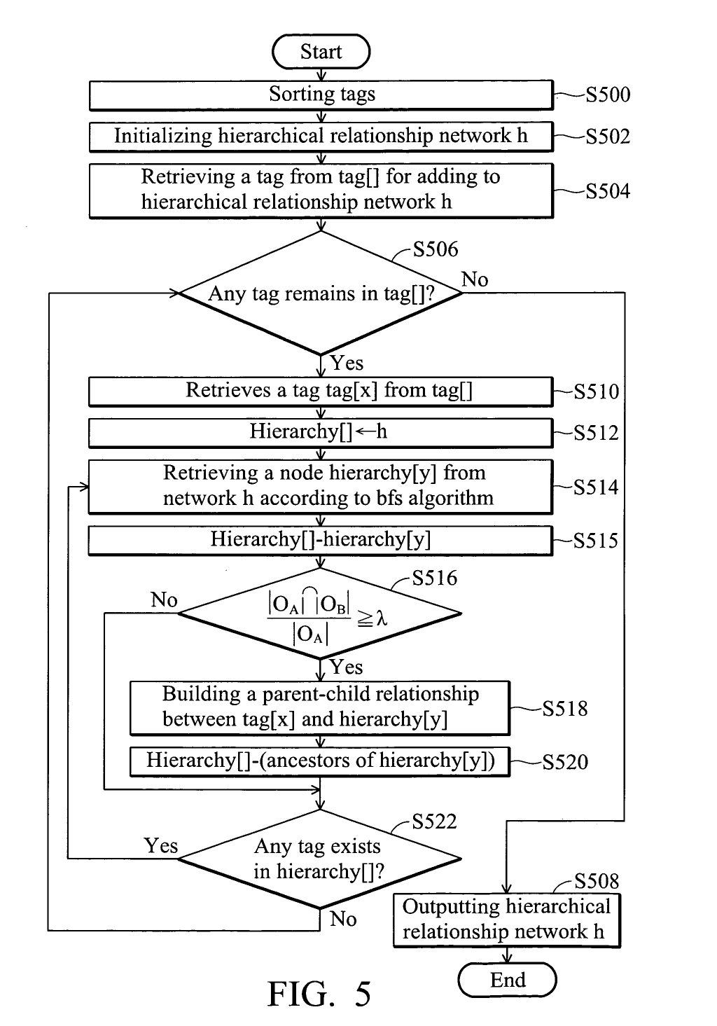

With reference to FIG. 5, organizer 122 executes the following steps. After sorting tags in repository 121 (step S500), organizer 122 initializes hierarchical relationship network H (step S502). As shown in FIG. 3a, organizer 122 inserts a root node S and a terminal node T to hierarchical relationship network H. The root node is assigned the parent node of any tags when the parent node thereof cannot be found through parent-child check operations.

Node T links to leaf nodes, i.e. nodes without any child node. The tag vector of the root node S may be set as [1 1 1 1 1 1]. Terminal[ ] and hierarchy[ ]currently comprise only the root node S.

Organizer 122 retrieves a tag from the sort result (tag “programming”) for adding to hierarchical relationship network H as a node (step S504). For example, as shown in FIG. 3b, when processing the tag “programming” as a current node, organizer 122 assigns root node S as the parent node of the current node.

Organizer 122 determines if any tag remains in Tag[ ] (step S506). If no, organizer 122 outputs hierarchical relationship network H to network buffer 123 (step S508). If yes, organizer 122 retrieves a tag Tag[x] as the current node from the sorted result Tag[ ] (step S510). The x is an integer. Organizer 122 copies all nodes from hierarchical relationship network H to hierarchy[ ] (step S512).

Organizer 122 retrieves a node as the target node hierarchy[y] under check from hierarchical relationship network H according to the breadth first search (BFS) algorithm beginning from terminal node T of the hierarchical relationship network H (step S514). The node is retrieved as the target node only when the node has a copy hierarchy[y] in hierarchy[ ]. The target node hierarchy[y] is then removed from hierarchy[ ] (step S515). Organizer 122 performs a parent-child check on the current node Tag[x] and the target node hierarchy[y] to determines if the current node Tag[x] and the target node hierarchy[y] satisfy the a condition (step S516):

The current node Tag[x] and the target node hierarchy[y] may be respectively referred to as a first tag and a second tag for simplicity. The network resources tagged by the first tag and the second tag respectively comprise a set O_{A} and a set O_{B}. In a parent-child check operation, a parent-child relationship may be built between the current node Tag[x] and the target node hierarchy[y] when the following formula is satisfied thereby:

$$\frac{\vert {O}_{A} ⋂ {O}_{B} \vert}{\vert {O}_{A} \vert} \geq λ \qquad ( 3 )$$

wherein λ comprises a predetermined number, and is set to 0.8 in the following. |O_{A}| is the number of network resource instances in the set O_{A}, and |O_{A}∩_{B}| is the number of network resource instances in the intersection of sets O_{A} and O_{B}.

In step S516, organizer 122 performs a parent-child check on the current node Tag[x] and the target node hierarchy[y], in which when network resources commonly tagged by the first and second tags satisfy the formula (3), organizer 122 builds a parent-child relationship between the first and second tags (step S518) and makes one of the first and second tags correspond to a greater range and the other correspond to a smaller range to be the parent node and the child node in the parent-child relationship respectively. A corresponding element in Tag_Relation[ ][ ] is set to “1”. If not, organizer 122 directly executes step S522. In step S522, organizer 122 determines if any tag exists in hierarchy[ ] (step S522). If so, step S514 is repeated. If not, step S506 is repeated. The root node is assigned the parent node of a tag when the parent node thereof cannot be found through parent-child check operations.

For example, when retrieving tag “java” as the current node, organizer 122 performs a parent-child check on tag “java” and tag “programming”. Then |O_{A}|=5 and

$$\frac{\vert {O}_{A} ⋂ {O}_{B} \vert}{\vert {O}_{A} \vert} = 0.8 \geq λ$$

is obtained. Thus, as shown in FIG. 3c, organizer 122 builds a parent-child relationship (denoted as link L1 in FIG. 3c) between tag “java” and tag “programming” (step S518) and making one of the two tags corresponding to a greater range and the other corresponding to a smaller range respectively the parent node and the child node in the parent-child relationship. Similarly, when retrieving tag “api” as the current node, organizer 122 obtains

$$\frac{\vert {O}_{A} ⋂ {O}_{B} \vert}{\vert {O}_{A} \vert} = 0.8 \geq λ .$$

### Thus, tag “java” becomes the parent node of tag “api”.

Note that when a checked target node (such as tag “java”) has been made the parent node of the current node (such as tag “api”), ancestor nodes (such as tag “programming”) of the target node is prevented from any further parent-child check with the same current node(such as tag “api”). Thus, organizer 122 removes the target node hierarchy[y] and all ancestor nodes thereof from hierarchy[ ] (step S520). Conversely, when a checked target node is not the parent node of the current node, ancestor nodes of the target node are still required to receive parent-child checks with the same current node (such as tag “api”).

For example, as shown in FIG. 3e, when organizer 122 retrieves tag “sun” as the current node and tag “api” as the target node,

$$\frac{\vert {O}_{A} ⋂ {O}_{B} \vert}{\vert {O}_{A} \vert} = \frac{3}{4} = 0.75 < λ$$

is obtained, so tag “api” is not the parent node of tag “sun”. Further parent-child checks on tag “java” and tag “sun” are required. When organizer 122 retrieves tag “sun” as the current node and tag “java” as the target node,

$$\frac{\vert {O}_{A} ⋂ {O}_{B} \vert}{\vert {O}_{A} \vert} = 1 > λ$$

is obtained, so tag “java” is set as the parent node of tag “sun”. The ancestor nodes (such as tag “programming”) of the tag “java” is prevented from any further parent-child check with the same current node(tag “sun”).

Similarly, with reference to FIGS. 3f, 3g, 3h, and 3i, organizer 122 adds tag “j2ee”, “C#”, “javascript”, and “jdk” to hierarchical relationship network H and obtains FIG. 3j.

Accordingly, constitution of hierarchical relationship network H comprises tag classification. Provided with tags A and B respectively corresponding to resource sets O_{A} and O_{B}, when the following conditions is satisfied:

(1). the corresponding range of tag A is greater than that of tag B, (i.e. |O_{A}|>|O_{B}|),

(2) tags A [symbol] B commonly correspond to common resources (i.e. O_{A}∩O_{B}≠Φ, where Φ is a null set),

(3) the common resources contribute a greater proportion in set O_{B} than a predetermined proportion (such as λ), i.e.

$$\frac{\vert {O}_{A} ⋂ {O}_{B} \vert}{\vert {O}_{A} \vert} \geq λ ,$$

it is determined that tag B belongs to tag A.

Assistance in Resource Search:Keyword Suggestion

Search module 142 receives a keyword for resource search. When the keyword matches a specific tag (such as “java”) in the hierarchical relationship network H, guide module 112 retrieves nodes adjacent to the specific tag. Search module 142 provides optional keywords for the resource search by displaying tags represented by the adjacent nodes. When a displayed tag is selected, search module 142 searches for network resources utilizing the selected tag as a search key.

Additionally, a parameter D may be utilized to configure the scope of nodes adjacent to the specific tag. For example, the parameter D is utilized to configure the distance between the specific tag and the nodes adjacent thereto, wherein each link is treated as one distance unit. When D=1, search module 131 displays tags one link away from the specific tag (including parent and child nodes thereof) through output module 150. For example, tags one link away from the tag “java” comprise “Sun”, “Programming”, “api”, and “jsp”. When D=2, search module 131 displays tags two links away from the specific tag (including parent, child, grandfather, and grandson nodes thereof) through output module 150. Tags two links away from the tag “java” further comprise “Javascript”, “l2ee”, “jdk”, “C#”, and “php”. The parameter D may be user adjustable.

Search module 131 may directly display hierarchical relationship network H or the nodes therein alphabetically sorted in form of TagCloud. Search module 131 may determine the sizes of tags according to the times used thereof.

Assistance in Resource Search:Search Result Ranking

Search module 131 receives strings or keywords through interface 142, utilizes the same for resource searches, locate and store search results to buffer 132. Arrangement module 133 utilizes the hierarchical relationship network H to calculate information density index for each instance of the resources. Organizer 122 may assign weight to relationships (i.e. links in network H) between tags according to the following formula. Tag vectors A and B of two tags are taken as an example to calculate cosine similarity therebetween as the weight of the two tags:

$$\frac{A \cdot B}{\vert A \vert \vert B \vert} \qquad ( 4 )$$

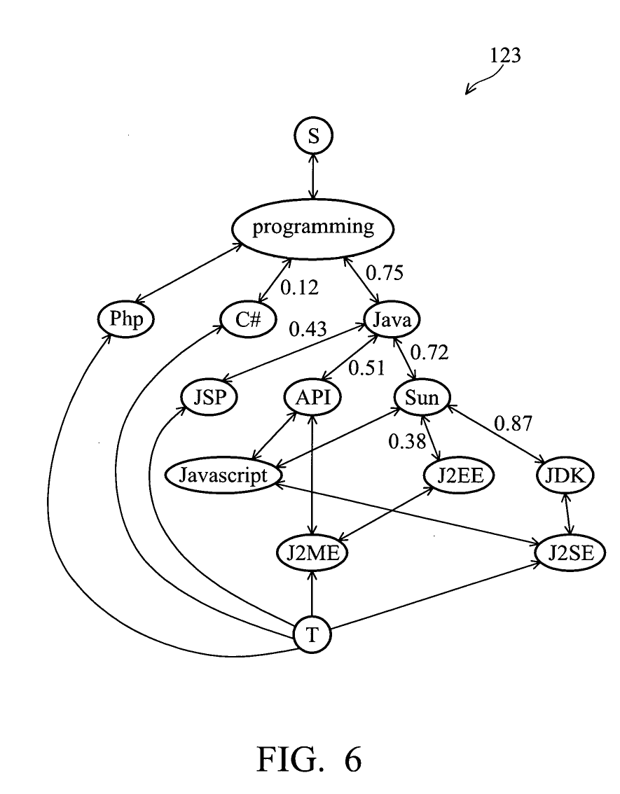

For example, the tag vector of tag “programming” is [ 1 1 0 1 1 1], the tag vector of tag “java” is [ 1 0 1 1 1 1], the tag vector of tag “API” is [ 1 1 1 1 1 0], the tag vector of tag “Sun” is [1 0 1 1 0 1], the tag vector of tag “J2EE” is [ 0 0 1 1 0 1], the tag vector of tag “C#” is [0 1 0 0 1 1], the tag vector of tag “JDK” is [1 0 0 1 0 1], and the tag vector of tag “JSP” is [1 0 0 1 0 0]. The weights of relationships between tags are shown in FIG. 6.

The following is a formula for calculating information density index for each instance of resources:

$$( {\sum }_{t = 1}^{k} S ) + ( {\sum }_{i = 1}^{n} ( S * {W}_{i} ) ) + ( {\sum }_{j = 1}^{m} ( S * {W}_{j} ) ) \qquad ( 5 )$$

S: the grade obtained when a located resource instance matches a tag utilized as a search key;

Wᵢ: the weight between the search key tag and a parent node and/or child nodes thereof;

Wⱼ: the weight between the search key tag and a grandfather node and/or grandson nodes thereof;

k, n, m: the located resource instance matches k tags, n parent/child nodes, and m grandfather/grandson nodes.

Thus, according to formula (5), when S=1, and a resource instance matches keyword “java”, the grade of information density index obtained is:

(1)+(0.75+0.43+0.51.0.72)+(0.38+0.87).

Arrangement module 133 may calculate information density index for resource instances in the search result according to formula (5), sort the resources based on the calculated information density index thereof, and store the sorted resources to buffer 132. Output module 150 displays the sorted network resources.

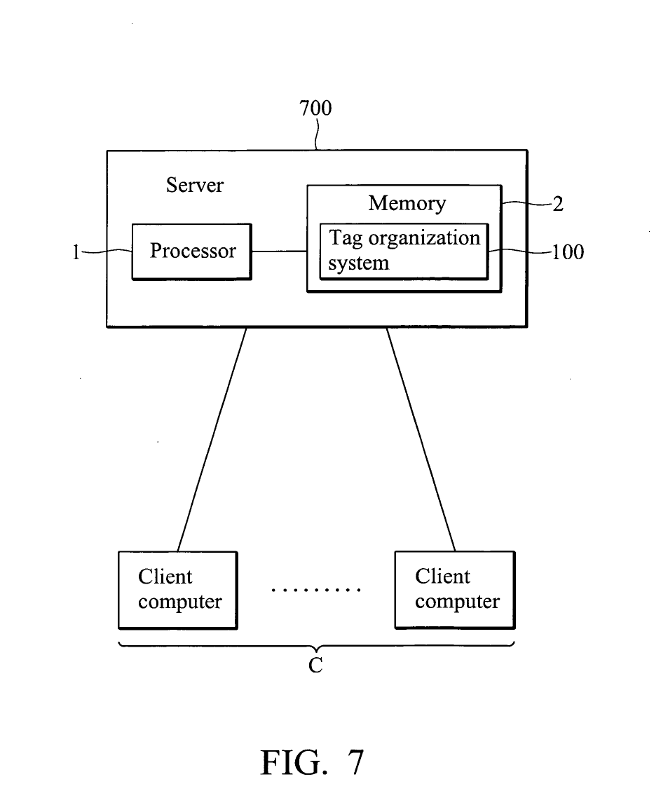

The tag organization method may be implemented by a computer program stored in a computer-readable storage medium. With reference to FIG. 7, system 100 may comprise a computer program executed by server 700. Memory 2 stores system 100 which, when loaded to server 700, directs processor 1 to execute the tag organization method. System 100 may be loaded to memory 2 of server 700 though cables or wireless communication channels from a disc, a hard disk, a portable disk drive, or other storage media.

Server 700 may be coupled to client computers C through a network. Client computers C input tags to system 100 through web browsers, and displays suggested optional tags, hierarchical relationship network H, and search results.

In conclusion, the tag organization system builds and provides a hierarchical relationship network of tags as the interface for resource searches, by which search scope can be adjusted by selecting tags at different levels of the hierarchical relationship network.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A tag organization method, comprising:
receiving a plurality of tags for tagging network resources;
determining the range of resources tagged by each tag;
generating a hierarchical relationship network of the tags by representing the tags as the constituent nodes in the network according to the determined range of each tag; and
utilizing the hierarchical relationship network to facilitate resource searches.

2. The method as claimed in claim 1, wherein the generation of the hierarchical relationship network of the tags further comprises:
retrieving a first tag and a second tag; and
performing on the first and second tags a parent-child check comprising:
when network resources commonly tagged by the first and second tags satisfy a condition, building a parent-child relationship between the first and second tags and making one of the first and second tags corresponding to a greater range and the other corresponding to a smaller range respectively to be the parent node and the child node in the parent-child relationship.

3. The method as claimed in claim 2, wherein the determined range of a tag comprises the number of instances of network resources tagged by the tag.

4. The method as claimed in claim 3, wherein the network resources tagged by the first tag and the second tag respectively comprise a set O_{A} and a set O_{B}, and the condition comprises the following formula:
$$\frac{\vert {O}_{A} ⋂ {O}_{B} \vert}{\vert {O}_{A} \vert} \geq λ$$
wherein λ comprises a predetermined number, |O_{A}| is the number of network resources in the set O_{A}, and |O_{A}∩O_{B}| is the number of network resources in the intersection of sets O_{A} and O_{B}.

5. The method as claimed in claim 2, further comprising:
a. sorting the tags based on the range of each tag;
b. initializing the hierarchical relationship network;
c. orderly retrieving a tag, referred to as the current tag, from the sorted tags;
d. according to the breadth first search (BFS) algorithm beginning from a terminal node of the hierarchical relationship network, orderly retrieving each node as a target node from the network and performing the parent-child check on the target node and,the current node, wherein, when the checked target node is made the parent node of the current node, preventing ancestor nodes of the target node from any further parent-child check with the same current node; and
e. repeating the steps c and d until all sorted tags are made nodes in the hierarchical relationship network.

6. The method as claimed in claim 1, wherein further comprising:
receiving a keyword for the resource search;
when the keyword matches a specific tag in the hierarchical relationship network, retrieving nodes adjacent to the specific tag; and
displaying tags represented by the adjacent nodes.

7. The method as claimed in claim 6, further comprising, when a displayed tag is selected, searching for network resources utilizing the selected tag as a search key.

8. The method as claimed in claim 6, further comprising utilizing a parameter indicating the distance between the specific tag and the nodes adjacent thereto.

9. The method as claimed in claim 1, further comprising:
when a set of network resources is located based on a tag as a search key, utilizing the hierarchical relationship network to calculate information density index for each instance of the network resources;
sorting the network resources based on the information density index thereof; and
displaying the sorted network resources.

10. A machine-readable storage medium storing a computer program which, when executed, directs a computer to perform the tag organization method as claimed in claim 1.

11. A tag organization system, comprising:
a tag handler receiving a plurality of tags for tagging network resources;
an organizer determining the range of resources tagged by each tag, generating a hierarchical relationship network of the tags according to the determined range of each tag, wherein nodes in the network respectively represent the tags; and
search module utilizing the hierarchical relationship network to facilitate resource.

12. The system as claimed in claim 11, wherein the organizer retrieves a first tag and a second tag, performs on the first and second tags a parent-child check comprising, when network resources commonly tagged by the first and second tags satisfy a condition, building a parent-child relationship between the first and second tags and making one of the first and second tags corresponding to a greater range and the other corresponding to a smaller range respectively to be the parent node and the child node in the parent-child relationship.

13. The system as claimed in claim 12, wherein the determined range of a tag comprises the number of instances of network resources tagged by the tag.

14. The system as claimed in claim 13, wherein the network resources tagged by the first tag and the second tag respectively comprise a set O_{A} and a set O_{B}, and the condition comprises the following formula:
$$\frac{\vert {O}_{A} ⋂ {O}_{B} \vert}{\vert {O}_{A} \vert} \geq λ$$
wherein λ comprises a predetermined number, |O_{A}| is the number of network resources in the set O_{A}, and |O_{A}∩O_{B}| is the number of network resources in the intersection of sets O_{A} and O_{B}.

15. The system as claimed in claim 12, wherein the organizer executes:
a. sorting the tags based on the range of each tag;
b. initializing the hierarchical relationship network;
c. orderly retrieving a tag, referred to as the current tag, from the sorted tags;
d. according to the breadth first search (BFS) algorithm starting from a terminal node of the hierarchical relationship network, orderly retrieving each node as a target node from the network and performing the parent-child check on the target node and the current node, wherein, when the checked target node is made the parent node of the current node, preventing ancestor nodes of the target node from any further parent-child check with the same current node; and
e. repeating the steps c and d until all sorted tags are made nodes in the hierarchical relationship network.

16. The system as claimed in claim 11, wherein the search module receives a keyword for the resource search, when the keyword matches a specific tag in the hierarchical relationship network, retrieves nodes adjacent to the specific tag, and displays tags represented by the adjacent nodes.

17. The system as claimed in claim 16, wherein, when a displayed tag is selected, the search module further searches for network resources utilizing the selected tag as a search key.

18. The system as claimed in claim 16, wherein the search module utilizes a parameter indicating the distance between the specific tag and the nodes adjacent thereto.

19. The system as claimed in claim 11, wherein in response to locating a set of network resources based on a tag as a search key, the search module utilizes the hierarchical relationship network to calculate information density index for each instance of the network resources, sorts the network resources based on the information density index thereof, and displays the sorted network resources.

20. A tag organization method, comprising:
receiving a plurality of tags for tagging network resources, comprising a first tag and a second tag;
determining the resource set tagged by each tag; and
classifying the first and second tags utilizing the following steps:
when the first and second tags respectively correspond to resource sets O_{A} and O_{B} with common resources, and the set O_{A} is greater than set O_{B}, and the proportion of the common resources in the set O_{B} is greater than a predetermined ratio, determining that the second tag belongs to the first tag.
